(19) United States
(12) Patent Application Publication
(10) Pub. No.: US 2010/0240811 A1
(43) Pub. Date: Sep. 23, 2010

(54) Thermosetting Resin Composition and Application Thereof

(76) Inventors: Yufang HE, Guangdong (CN); Lunqiang ZHANG, Guangdong (CN)

Correspondence Address: Dr. BANGER SHIA;Patent Office of Bang Shia, 102 Lindencrest Ct, Sugar Land, TX, 77479-5201, US

(21) Appl. No.: 12/406,877

(22) Filed: Mar. 18, 2009

(51) Int. Cl. C08L 63/00; C08K 5/3417; C08K 5/50; C08K 5/136; C08K 3/38; C08K 3/28; C08K 3/22; C08K 3/34; C08K 3/36; C08K 3/40; C08K 3/04

(52) U.S. Cl. 524/94; 524/105; 524/154; 524/186; 524/330; 524/405; 524/428; 524/430; 524/442; 524/445; 524/449; 524/451; 524/540; 525/418; 525/452; 525/507; 525/529; 525/187

(57) ABSTRACT

The present invention discloses a thermosetting resin composition including: a bi-functional or multi-functional epoxy resin, a SMA uses as a curing agent, an allyl phenol such as diallyl bisphenol A used as a co-curing agent and a toughening agent a low-bromine or high-bromine BPA epoxy resin or tetrabromobispheno A (TBBPA or TBBA) uses as a flame retardant agent, and an appropriate solvent. After the resin composition of the invention is cured, the resin composition has lower dielectric property and better thermal reliability and tenacity. A copper clad laminate made of an enhanced material such as glass fiber has lower dielectric constant (Dk) and loss tangent (Df), high Tg, high thermal decomposition temperature (Td), better tenacity and PCB manufacturability, and thus very suitable to be used as a copper clad laminate and a prepreg for manufacturing PCBs or applied as a molding resin material for contraction, automobile and air navigation.

### BACKGROUND OF THE INVENTION

(a) Field of the Invention

The present invention generally relates to a thermosetting resin composition applicable for manufacturing a laminate and a prepreg of a printed circuit board (PCB), and used as a common application of an epoxy resin such as a molding resin and a composite material used for architecture, automobile and air navigation.

(b) Description of the Related Art

Epoxy resin has been used extensively in various types of electronic insulating materials, mainly because the epoxy resin has better heat resistance, chemical resistance, insulability and dielectric property, and common curing agents include amines, anhydrides and phenols or phenolic compounds, particularly in the applications for copper clad laminates, and common dicyandiamides (amines) and phenolic resins (phenolic compounds) serve as epoxy resin curing agents and come with better manufacturability, thermal resistance, chemical resistance and insurability, but their dielectric property cannot satisfy the comprehensive requirements of high-frequency signal transmissions, due to higher dielectric constant and dissipation factor.

Belgium Pat. No. 627,887 disclosed a styrene-maleic anhydride (SMA) copolymer used as an epoxy resin curing agent, but such epoxy resin composition has the shortcomings such as a lower glass transition temperature (Tg), a poorer thermal stability and a poorer manufacturability after the crosslinking takes place.

European Pat. No. 413,386 disclosed a composition of this sort that uses a low-priced bi-functional epoxy resin to substitute the higher-priced multi-functional epoxy resin to achieve the thermal performance of the same desired level. However, this patent relates to an application of IPN polymerization, wherein the epoxy resin curing agent is polybrominated phenol, and the practical application of the anhydride curing agent shows that the result is unsatisfactory, particularly the cross-linked Tg is too low and the electric property and the stability of the prepreg require improvements.

In the application of SMA as disclosed in German Pat. No. 383,9105, a co-crosslinking agent (dicyanodiamide) is a basic ingredient of the resin composition, but dicyanodiamide can be dissolved in a poisonous and expensive solvent only, and thus it is preferably to have an appropriate co-crosslinking agent to overcome the shortcomings of dicyanodiamide.

U.S. Pat. No. 4,042,550 disclosed an epoxy resin composition which is a polymer with a low molecular weight and comprised of α-methyl styrene and maleic anhydride, but such composition is inapplicable for manufacturing PCBs.

If SMA is used as an epoxy resin curing agent, the crosslinked matter will be more fragile, such that when SMA is used as a prepreg for manufacturing a printed circuit board (PCB), and the resin at the edge of the prepreg will be spread open like mushroom spores during a cutting process, and such phenomenon is also called the “Mushroom Effect” which is inapplicable for manufacturing prepregs.

Since the epoxy resin composition simply using SMA as the curing agent is more fragile, a method of improving the fragility disclosed in WIPO Pat. No. 9,818,845 applies the resin composition to a prepreg of a PCB and uses tetrabromobispheno A (TBBPA or TBBA), tetrabromobispheno A diglycidyl ether (TBBAPDGE) or their mixture as a co-crosslinking agent, and the SMA as a crosslinking agent to cure a FR-4 epoxy resin to improve the high tenacity, Tg and stability. Although the fragility of the cured composition can be improved, yet the peeling strength becomes lower, wherein the 1-oz peeling strength is lower than 7.0 lb/in, and thus such composition is not applicable for manufacturing small circuits. The fragility is still low, and the manufacturability of PCB bores is power, and thus causing a poor reliability of PCBs.

P.R.C. Pat. Nos. 1935896A, 1955217A and 1955219A also disclosed applications of the SMA cured epoxy resin, and these applications simply introduce the structure of SMA with a low dielectric property to the structure of a polymer to achieve better thermal resistance and dielectric property. Like the aforementioned patents, these patents have not overcome the shortcomings including the low fragility of the crosslinked matter.

The structure of an allyl group is usually used for improving the tenacity of an epoxy resin composition after the epoxy resin composition is cured. By the IPN polymerization, the allyl groups are introduced to form soft chains of fats. In U.S. Pat. No. 2,707,177, DE3521506, GB994484 and EP417837, amide is used as an allyl epoxy resin composition of an epoxy resin curing agent, but the amides of this sort is an olefinic unsaturated amide such as maleic anhydride. In addition to the function of curing the epoxy resin, the amides of this sort cure also come with unsaturated double-bonds for forming an allyl network.

In Pat. No. WO9607683, another IPN polymer resin composition was disclosed, and the difference of this resin composition from the aforementioned IPN polymers resides on that olefinic unsaturated amide and maleic anhydride are used to form polymers, and the amide of the polymer becomes a functional group for reacting with the epoxy resin. Since the alkenyl group of the olefinic unsaturated amide is polymerized with the double bond of the maleic anhydride, the alkenyl group is not in the double bond while participating the allyl network, and the reaction only takes place at the double bond existed among the allyl groups and forms an IPN structure by the crosslinked structure of the amide for curing the epoxy resin. Since the allyl compound is triallyl cyanurate (TAC) or triallyl isocyanurate (TAIC), the water absorbability of its molecular structure is higher, and the number of C—N groups in the molecular structure is greater, therefore its cured composition has the drawback of a lower thermal resistance such as higher water absorbability, dielectric property and thermal decomposition temperature, etc.

In view of the foregoing shortcomings of the resin composition, the inventor of the present invention developed a novel resin composition whose alkenyl group in olefinic unsaturated amide forms a SMA polymer and will not participate in the formation of an allyl network compound, and such resin composition includes an allyl phenol such as diallyl bisphenol A. The allyl network and the SMA/epoxy resin crosslinking network forms an IPN, and the phenoxyl group of the allyl phenol participates in the crosslinking of the epoxy resin to assure that the thermal resistance will not drop, while the fragility of the cured resin composition can be improved to achieve a lower water absorbability to assure a lower dielectric property.

### SUMMARY OF THE INVENTION

Therefore, it is a primary objective of the present invention to provide a thermosetting resin composition to assure that the thermal resistance will not be lowered and improve the fragility of the resin composition after the resin composition is cured, so as to achieve lower water absorbability and assure lower dielectric property.

To achieve the foregoing objective, the present invention provides a thermosetting resin composition comprised of: bi-functional or multi-functional epoxy resin, SMA as a curing agent, allyl phenol of diallyl bisphenol A as a co-curing agent and a toughening agent, low-bromine or high-bromine BPA epoxy resin or tetrabromobispheno A (TBBPA or TBBA) as a flame retardant agent, appropriate accelerator and solvent.

The epoxy resin is a glycidyl amine epoxy resin reacted with BPA, BPF, bisphenol-S (BPS) or alkyl substituted bisphenol diglycidyl ether, phenol novolac epoxy (PNE), cresol novolac epoxy (CNE), Bis-phenol-A novolac epoxy (BNE), resorcinol-formaldehyde epoxy resin, diphenyl benzidine or amide and epichlorohydrin of isocyanuric acid, a phenolic/alkyl glycidyl ether epoxy resin of triphenol methane triglycityl ether, a condensed resin of the epoxy resin of dicyclopentadiene or cyclopentadiene and phenols, an isocyanate modified epoxy resin, having a naphthalene-ring epoxy resin, a hydantion epoxy resin, a terpene-modified epoxy resin, a 9,10-dihydro-9-oxa-10-phosphaphenanthrene-10-oxide or a 9,10-dihydro-9-oxa-10-(2′,5′-dihydroxyl phenyl)phosphaphenanthrene-10-oxide (DOPO-HQ) modified phosphor containing epoxy resin, and the epoxy resins can be used individually or in any combination.

The SMA acts as an epoxy resin curing agent in the resin system for introducing a styrene structure with a good dielectric property into a crosslinked structure to achieve low dielectric constant and dissipation factor. The SMA with a high molecular weight (generally higher than 60000) has a poor compatibility with the epoxym, and the weight percentage of amide is lower (generally lower than 3%), and thus SMA is not suitable to be used as the epoxy resin curing agent for the application of manufacturing SMA/epoxy printed circuit boards. Experiments show that SMA with a weight percentage of amide over 3% can be used as an epoxy resin curing agent for manufacturing printed circuit boards if the molecular weight (Mw) falls within a range from 3000 to 60000, particularly in the range of 5000 to 12000. If a SMA and its mixture with a mole ratio of styrene (S): maleic anhydride (MA) equal to 1:1, 2:1, 3:1 and 4:1 such as the Sartomer Company's SMA1000, SMA2000, SMA3000 (or SMA EF-30) and SMA4000 (or SMA EF-40) is used for manufacturing printed circuit boards, the SMA provides a good thermal reliability and a low dielectric property and gives an excellent manufacturability for the printed circuit board. In the SMA used as an epoxy resin curing agent for the manufacture of printed circuit boards, the equivalence ratio (SMA amide and phenoxyl group: epoxy resin) should fall within a range from 0.6:1 to 1.6:1, preferably within a range from 0.9:1 to 1.1:1).

The allyl phenol is a phenol with a substituted allyl group at an adjacent position, an opposite position or an in-between position of a benzene ring, such as diallyl bisphenol A (DABPA), and 2,4,6-triallyl phenol, etc, and its chemical structural formula is given below:

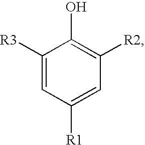

R1,R2,R3: —H,—CH₂—CH═CH₂,—CH₃ (at least one of the R1, R2 and R3 is —CH₂—CH═CH₂),

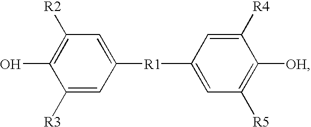

R2,R3,R4,R5: —H,—CH₂—CH═CH₂,—CH₃ (at least one of the R2, R3, R4 and R5 is —CH₂—CH═CH₂),

The structure of R1 is given below:

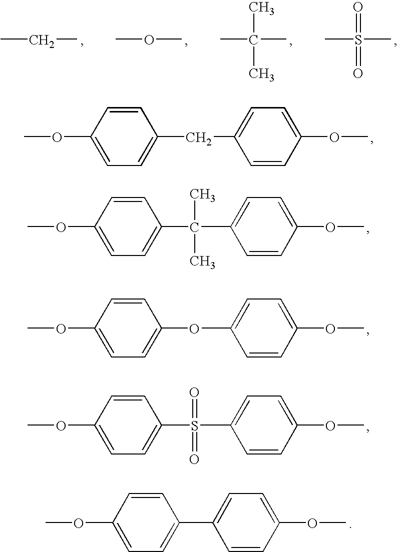

The phenoxyl group of the allyl phenol can be reacted with the epoxy group of the epoxy resin to produce a crosslinked structure, while the allyl group is self-polymerized to form a crosslinked structure by specific initiator and high temperature, and this crosslinked structure is reacted with the crosslinked structure of the allyl phenol hydroxyl group, SMA amide and epoxy group to form an interpenetrating network (IPN), such that the final polymer has a better tenacity due to the addition of the allyl polymer network. Since the allyl phenol is reacted in a chemical crosslink to maintain the polymer at an original thermal reliability and other excellent properties.

The aforementioned flame retardant agent includes a low-bromine BPA epoxy resin, such as the FR-4 epoxy resin (BET-535), a high-bromine BPA epoxy resin, such as BET-400, or a high bromine-content tetrabromobispheno A (TBBPA or TBBA) that can be reacted with the SMA or the epoxy resin to form a crosslinked structure and achieve a better flame retardability. In the meantime, the reliability including the thermal reliability of the cured polymer will not be affected. The added portion of bromine flame retardant agent such as the ethylenebistetrabromophthalimide (whose product name is SAYTEX BT-93) can help achieving a better flame resisting effect, and its chemical structural formula is given below:

FIG.3

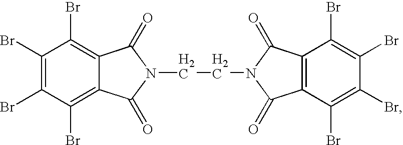

Ethane-1,2-bis(pentabromophenyl) (Product Name is SAYTEX 8010) has a chemical structural formula as given below:

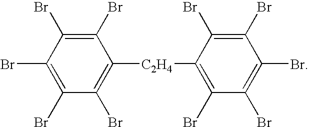

The accelerator used in the present invention is a commonly used imidazol accelerator, particularly 2-methyl-imidazol, 2-ethyl-4-methyl-imidazol, 2-phenyl-imidazol and 2-ethyl-4-phenyl-imidazol; or a primary, secondary or tertiary amine, an ammonium salt, and a phosphamidon salt selected from the collection of benzyldimethylamine (BDMA), butyltriphenylphosphonium bromide and 4,4′- and 3,3′-diamino diphenyl sulfone; or a peroxide initiator (such as tert-butyl perbenzoate, TBPB), an azo initiator (such as azodiisobutyronitrile) and an organic metal salt or a complex (such as zinc acetate), or a Lewis acid; and the accelerators can be used independently for expediting the reaction speed of the curing or in a proportion of 0.001% to 5%, preferably 0.01˜2%.

The common used solvent of the invention can be an etone (such as acetone, methyl ethyl ketone, and cyclohexanone), aromatic group (such as toluene), glycol ether (such as propylene glycol mono-methyl ether) solvent, or a mixture of the above.

To increase the glass transition temperature (Tg) of the resin composition of the invention, a portion of cyanate ester (such as cyanate ester, BA-230S) or polyimide resin of the bismaleimide are usually added into the resin composition of the invention to form a higher crosslinking density to achieve a higher Tg (over 200° C.).

The rubber or rubber modified compound can be a rubber modified epoxy resin such as styrene/butadiene copolymer, butadiene/styrene and methyl methacrylate or other vinyl polymer, polymethyl methacrylate/butadiene/styrene rubber core-shell particles or their modified epoxy resin or phenolic resin, polydimethylsiloxane core-shell particles or their modified epoxy resin or phenolic resin, CTBN, and works together with allyl phenol to increase the tenacity of the resin composition. The toughening agent of the resin composition of the invention further comprises an allyl phenol reduced to form ether such as diallyl bisphenol A ether.

The resin composition of the invention further comprises an appropriate filling material for lowering the coefficient of expansion of the resin composition for manufacturing the printed circuit boards, and the filling can be silicon dioxide (including crystalline, melted type, hollow and spherical silicon dioxide), aluminum oxide, mica, talcum powder, boron oxide, aluminum nitride, silicon carbide, diamond, burned clay, aluminum oxide, aluminum nitride fiber, glass fiber, or any combination of the above.

The resin composition of the invention further comprises an additive such as a defoaming agent, a coupling agent, a leveling agent, a dye, and a pigment, etc.

The present invention adopts an unsaturated amide having styrene-containing double bonds and ethyl styrene polymer (such as SMA) as a curing agent for improving the thermal resistance and the dielectric property effectively.

After the resin composition of the invention is cured, the resin composition has lower dielectric property and better thermal reliability and tenacity, and a copper clad laminate manufactured by an enhanced material such as glass fiber comes with lower dielectric constant (Dk) and loss tangent (Df), higher Tg and thermal decomposition temperature (Td) and better tenacity and PCB manufacturability, and thus the resin composition of the invention is very suitable to be used for the copper clad laminate and prepreg for manufacturing PCBs. In addition, the low dielectric property, high thermal reliability and good tenacity of the resin composition can be applied as a molding resin in the area of the complex material used for construction, automobile and air navigation.

### DETAILED DESCRIPTION OF THE PREFERRED EMBODIMENTS

In the method of the present invention, resins and solvents are mixed with resin solution uniformly, and then a 2116 glass cloth is dipped into the uniformly mixed resin solution, and baked at 170° C. for 5 minutes to dry the solvent to form a prepreg, and 8 pieces of 2116 prepregs and upper and lower 1-oz HTE copper clad laminate are put into a vacuum hot pressing machine at a high temperature for the curing process, and the curing conditions of over 190° C. for over 100 minutes are assured, and the pressure is 350 PSI. The IPC-TM-650 testing standard is used for testing the physical and electrical properties of the copper clad laminate. The following embodiments of the invention adopt this method.

The following embodiments are provided for illustrating the present invention only, but not intended for limiting the scope of the invention.

### Embodiments 1˜5

If the equivalences of amide, phenoxyl group and epoxy vary, the Tg of the copper clad laminate manufactured by the resin composition in accordance with the aforementioned experiment method will vary accordingly. The variations of Tg are listed in Table 1. If the equivalence ratio falls within 0.9:1.0 to 1.1:1, the Tg of the copper clad laminate will be maximized.

TABLE 1

| | Embodiment No. | | | | |
|---|---|---|---|---|---|
| | 1 | 2 | 3 | 4 | 5 |
| Amide Equivalence + Phenoxyl | 1.6 | 1.3 | 1.1 | 0.9 | 0.6 |
| Group Equivalence | | | | | |
| Epoxy Equivalence | 1 | 1 | 1 | 1 | 1 |
| Tg (DSC) (° C.) | 162 | 165 | 185 | 175 | 138 |

Note:
The quantity of each ingredient listed in the table is computed at a solid state of the ingredient.

### Embodiment 6 (Proportion)

A resin composition is prepared according to the following formula: Firstly, 192 g of methyl ethyl ketone (MEK) solvent is used for dissolving 156 g of SMA3000 and 40 g of TBBA, and then 185 g of BET-535A80 (with 80% of a solid content and 20% of acetone solvent) and 93.3 g of BET-400T60 (with 60% of a solid content and 40% of toluene solvent) are added, and finally 0.12 g of 2-ethyl-4-methyl-imidazol (2E4Mz) is blended with the solution uniformly for 2 hours. A copper clad laminate is produced in accordance with the aforementioned method and its physical and electrical properties are tested. In this embodiment, the ratio of the sum of equivalences of amide and phenoxyl group to the equivalence of epoxy is 1.1:1.

### Embodiment 7 (Proportion)

A resin composition is prepared according to the following formula: Firstly, 200 g of methyl ethyl ketone (MEK) solvent is used for dissolving 140 g of SMA3000 and 36 g of TBBA, and then 165 g of BET-535A80 (with 80% of a solid content and 20% of acetone solvent) and 86.7 g of BET-400T60 (with 60% of a solid content and 40% of toluene solvent) and 40 g of TAC are added, and finally 0.4 g of tert-butyl perbenzoate (TBPB) and 0.12 g of 2E4Mz are blended with the solution uniformly for 2 hours. A copper clad laminate is produced in accordance with the aforementioned method and its physical and electrical properties are tested. In this embodiment, the ratio of the sum of equivalences of amide and phenoxyl group to the equivalence of epoxy is 1.1:1.

### Embodiment 8

A resin composition is prepared according to the following formula: Firstly, 192 g of methyl ethyl ketone (MEK) solvent is used for dissolving 160 g of SMA4000 and 20 g of TBBA, and then 130 g of BET-535A80 (with 80% of a solid content and 20% of acetone solvent) and 160 g of BET-400T60 (with 60% of a solid content and 40% of toluene solvent) and 20 g of DABPA are added, and finally 0.2 g of tert-butyl perbenzoate (TBPB) and 0.12 g of 2E4Mz are blended with the solution uniformly for 2 hours. A copper clad laminate is produced in accordance with the aforementioned method and its physical and electrical properties are tested. In this embodiment, the ratio of the sum of equivalences of amide and phenoxyl group to the equivalence of epoxy is 1.1:1.

### Embodiment 9

A resin composition is prepared according to the following formula: Firstly, 176 g of methyl ethyl ketone (MEK) solvent is used for dissolving 156 g of SMA3000 and 12 g of TBBA, and then 145 g of BET-535A80 (with 80% of a solid content and 20% of acetone solvent) and 160 g of BET-400T60 (with 60% of a solid content and 40% of toluene solvent) and 20 g of DABPA are added, and finally 0.2 g of tert-butyl perbenzoate (TBPB) and 0.12 g of 2E4Mz are blended with the solution uniformly for 2 hours. A copper clad laminate is produced in accordance with the aforementioned method and its physical and electrical properties are tested. In this embodiment, the ratio of the sum of equivalences of amide and phenoxyl group to the equivalence of epoxy is 1.1:1.

### Embodiment 10

A resin composition is prepared according to the following formula: Firstly, 168 g of methyl ethyl ketone (MEK) solvent is used for dissolving 108 g of SMA1000, and then 255 g of BET-535A80 (with 80% of a solid content and 20% of acetone solvent) and 113.3 g of BET-400T60 (with 60% of a solid content and 40% of toluene solvent) and 20 g of DABPA are added, and finally 0.2 g of tert-butyl perbenzoate (TBPB) and 0.12 g of 2E4Mz are blended with the solution uniformly for 2 hours. A copper clad laminate is produced in accordance with the aforementioned method and its physical and electrical properties are tested. In this embodiment, the ratio of the sum of equivalences of amide and phenoxyl group to the equivalence of epoxy is 1.1:1.

### Embodiment 11

A resin composition is prepared according to the following formula: Firstly, 160 g of methyl ethyl ketone (MEK) solvent is used for dissolving 124 g of SMA3000 and 12 g of TBBA, and then 165 g of BET-535A80 (with 80% of a solid content and 20% of acetone solvent), 160 g of BET-400T60 (with 60% of a solid content and 40% of toluene solvent), 21.3 g of BA-230S (with 75% of a solid content and 25% of MEK solvent) and 20 g of DABPA are added, and finally 0.2 g of tert-butyl perbenzoate (TBPB) and 0.12 g of 2E4Mz are blended with the solution uniformly for 2 hours. A copper clad laminate is produced in accordance with the aforementioned method and its physical and electrical properties are tested. In this embodiment, the ratio of the sum of equivalences of amide and phenoxyl group to the equivalence of epoxy is 1.1:1.

### Embodiment 12

A resin composition is prepared according to the following formula: Firstly, 160 g of methyl ethyl ketone (MEK) solvent is used for dissolving 124 g of SMA3000 and 12 g of TBBA, and then 165 g of BET-535A80 (with 80% of a solid content and 20% of acetone solvent), 160 g of BET-400T60 (with 60% of a solid content and 40% of toluene solvent), 21.3 g of BA-230S (with 75% of a solid content and 25% of MEK solvent) and 20 g of DABPA are added, and 0.2 g of tert-butyl perbenzoate (TBPB), 0.08 g of zinc acetate and 0.12 g of 2E4Mz are blended with the solution uniformly for 0.5 hour, and finally 100 g of melted silicon dioxide is blended with the solution for 2 hours. A copper clad laminate is produced in accordance with the aforementioned method and its physical and electrical properties are tested. In this embodiment, the ratio of the sum of equivalences of amide and phenoxyl group to the equivalence of epoxy is 1.1:1.

### Embodiment 13

A resin composition is prepared according to the following formula: Firstly, 184 g of methyl ethyl ketone (MEK) solvent is used for dissolving 148 g of SMA3000 and 12 g of TBBA, and then 145 g of BET-535A80 (with 80% of a solid content and 20% of acetone solvent), 140 g of BET-400T60 (with 60% of a solid content and 40% of toluene solvent), 20 g of DABPA and 20 g of polymethyl methacrylate/butadiene/styrene core-shell particles are added, and finally 0.2 g of tert-butyl perbenzoate (TBPB) and 0.12 g of 2E4Mz are blended with the solution uniformly for 2 hours. A copper clad laminate is produced in accordance with the aforementioned method and its physical and electrical properties are tested. In this embodiment, the ratio of the sum of equivalences of amide and phenoxyl group to the equivalence of epoxy is 1.1:1.

The proportion of the resin composition in accordance with Embodiments 6˜13 and the properties of the copper clad laminate made of the resin composition are listed in Table 2. Compared with Embodiment 6, Embodiments 9 and 13 add DABPA or/polymethyl methacrylate/butadiene/styrene core-shell particles to improve the tenacity of the composition significantly, so as to improve the peeling strength, while the thermal resistance remains at a high level. Compared with Embodiment 7, Embodiments 9 and 13 have a lower Dk, and a better thermal resistance. The DABPA or polymethyl methacrylate/butadiene/styrene core-shell particles increase the tenacity and maintain a lower Dk and better thermal resistance over the TAC. In addition, Embodiments 11 and 12 add cyanate ester to improve the Tg of the composition significantly, while the Embodiment 12 adds an organic filling to lower the coefficient of expansion of the resin composition and improve the reliability of the resin composition applied to the PCB. In Embodiments 8˜10, the mole ratio of S:MA in the SMA is equal to 4:1, 3:1 and 1:1, and the manufactured copper clad laminate can have a lower dielectric property, a better thermal resistance and better tenacity. As the proportion of styrene in the SMA increases, the Tg will drop accordingly, but the Dk or Df will also drop.

TABLE 2

| | Embodiment No. | | | | | | | |
|---|---|---|---|---|---|---|---|---|
| | 6 | 7 | | | | | | |
| | (Proportion) | (Proportion) | 8 | 9 | 10 | 11 | 12 | 13 |
| BET-535 | 37 | 33 | 26 | 29 | 51 | 33 | 33 | 29 |
| TBBA | 10 | 9 | 5 | 3 | / | 3 | 3 | 3 |
| BET-400 | 14 | 13 | 24 | 24 | 17 | 24 | 24 | 21 |
| SMA4000 | / | / | 40 | / | / | / | / | / |
| SMA3000 | 39 | 35 | / | 39 | / | 31 | 31 | 37 |
| (or EF-30) | | | | | | | | |
| SMA1000 | / | / | / | / | 27 | / | / | / |
| TAC | / | 10 | / | / | / | / | / | / |
| DABPA | / | / | 5 | 5 | 5 | 5 | 5 | 5 |
| Polymethyl | / | / | / | / | / | / | / | 5 |
| methacrylate/ | | | | | | | | |
| butadiene/ | | | | | | | | |
| styrene | | | | | | | | |
| core-shell | | | | | | | | |
| particles | | | | | | | | |
| BA-230S | / | / | / | / | / | 4 | 4 | / |
| Melted | / | / | / | / | / | / | 25 | / |
| Silicon | | | | | | | | |
| Dioxide | | | | | | | | |
| 2E4Mz | 0.03 | 0.03 | 0.03 | 0.03 | 0.03 | 0.03 | 0.03 | 0.03 |
| Tert-butyl | / | 0.1 | 0.05 | 0.05 | 0.05 | 0.05 | 0.05 | 0.05 |
| Perbenzoate | | | | | | | | |
| (TBPB) | | | | | | | | |
| Zinc Acetate | / | / | / | / | / | 0.02 | 0.02 | / |
| Tg (DSC) | 178 | 182 | 180 | 188 | 198 | 201 | 199 | 182 |
| (° C.) | | | | | | | | |
| Td (5% Wt. | 365 | 361 | 368 | 365 | 361 | 351 | 349 | 366 |
| Loss) (° C.) | | | | | | | | |
| Peeling | 6.55 | 6.81 | 6.93 | 7.28 | 7.98 | 7.44 | 7.24 | 7.54 |
| Strength | | | | | | | | |
| (lb/in) | | | | | | | | |
| Dk | 3.76 | 3.71 | 3.65 | 3.73 | 3.89 | 3.75 | 3.85 | 3.70 |
| (100 MHz) | | | | | | | | |
| Df | 0.0090 | 0.0081 | 0.0078 | 0.0087 | 0.0129 | 0.0099 | 0.0088 | 0.0087 |
| (100 MHz) | | | | | | | | |
| α1(ppm/° C.) | 76 | 70 | 78 | 72 | 74 | 68 | 50 | 85 |
| Bending | 48.8 | 41.9 | 42.4 | 43.3 | 45.4 | 44.6 | 48.2 | 41.3 |
| Modulus | | | | | | | | |
| (GPa) | | | | | | | | |

Note:
The quantity of each ingredient listed in the table is computed at a solid state of the ingredient, and α1 is the coefficient of expansion at Tg.

What is claimed is:

1. A thermosetting resin composition, comprising: a bi-functional or multi-functional epoxy resin, a styrene-maleic anhydride (SMA) used as a curing agent, an allyl phenol used as a co-curing agent and a toughening agent, a low-bromine or high-bromine BPA epoxy resin or a tetrabromobispheno A used as a flame retardant agent, an accelerator and a solvent.

2. The thermosetting resin composition as claimed in claim 1, wherein the epoxy resin is a glycidyl amine epoxy resin reacted with BPA, BPF, bisphenol-S (BPS) or alkyl substituted bisphenol diglycidyl ether, phenol novolac epoxy (PNE), cresol novolac epoxy (CNE), Bis-phenol-A novolac epoxy (BNE), resorcinol-formaldehyde epoxy resin, diphenyl benzidine or amide and epichlorohydrin of isocyanuric acid, a phenolic/alkyl glycidyl ether epoxy resin of triphenol methane triglycityl ether, a condensed resin of the epoxy resin of dicyclopentadiene or cyclopentadiene and phenols, an isocyanate modified epoxy resin, having a naphthalene-ring epoxy resin, a hydantion epoxy resin, a terpene-modified epoxy resin, a 9,10-dihydro-9-oxa-10-phosphaphenanthrene-10-oxide or a 9,10-dihydro-9-oxa-10-(2′,5′-dihydroxyl phenyl)phosphaphenanthrene-10-oxide modified phosphor containing epoxy resin, and the epoxy resins can be used individually or in any combination.

3. The thermosetting resin composition as claimed in claim 1, wherein the SMA has a molecular weight falling within a range from 3000 to 60000, and the amide has a weight percentage over 3%.

4. The thermosetting resin composition as claimed in claim 3, wherein the SMA has a molecular weight falling within a range from 5000 to 12000 and a mole ratio of styrene: maleic anhydride falling within a range of 1˜4:1.

5. The thermosetting resin composition as claimed in claim 1, wherein the SMA amide has an equivalence ratio of phenoxyl group: epoxy resin falling within a range of 0.6:1 to 1.6:1.

6. The thermosetting resin composition as claimed in claim 1, wherein the allyl phenol is phenol with an allyl group substituted at an adjacent position, an opposite position or an in-between position of a benzene ring, and having a chemical structural formula of: 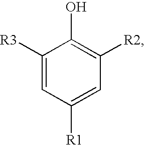
R1,R2,R3: —H,—CH₂—CH═CH₂,—CH₃ (wherein at least one of the R1, R2 and R3 is —CH₂—CH═CH₂), 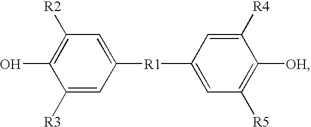
R2,R3,R4,R5: —H,—CH₂—CH═CH₂,—CH₃ (wherein at least one of the R2, R3, R4 and R5 is —CH₂—CH═CH₂),
and the R1 has a structural formula of:

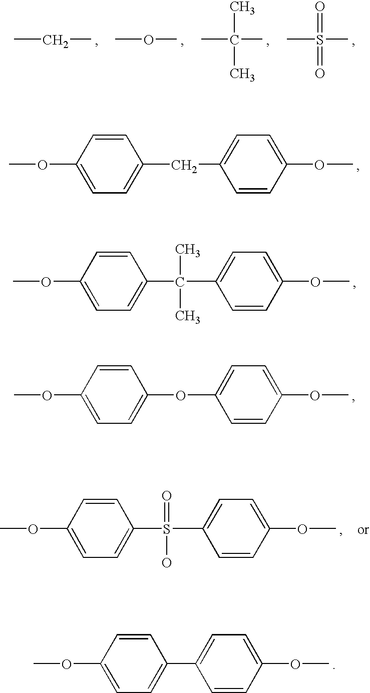

7. The thermosetting resin composition as claimed in claim 1, wherein the flame retardant agent is one selected from the collection of BET-535, BET-400, TBBPA, TBB, and partially added additive bromine flame retardant agent, and having a chemical structural formula of:

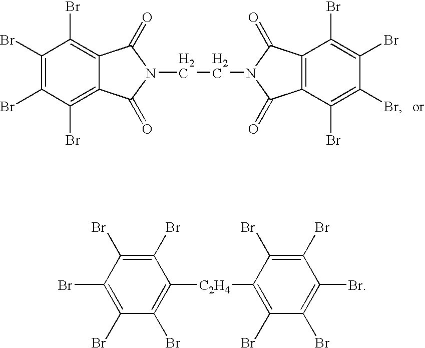

8. The thermosetting resin composition as claimed in claim 1, wherein the accelerator is an imidazol accelerator selected from the collection of 2-methyl-imidazol, 2-ethyl-4-methyl-imidazol, 2-phenyl-imidazol and 2-ethyl-4-phenyl-imidazol; or a primary, secondary or tertiary amine, an ammonium salt, and a phosphamidon salt selected from the collection of benzyldimethylamine (BDMA), butyltriphenylphosphonium bromide and 4,4′- and 3,3′-diamino diphenyl sulfone; or a peroxide initiator, an azo initiator and an organic metal salt or a complex; or a Lewis acid; and the accelerators can be used individually or in any combination; and the proportion of accelerator used with respect to the epoxy resin is 0.001% to 5%.

9. The thermosetting resin composition as claimed in claim 1, wherein the solvent is one selected from the collection of an etone solvent, an aromatic solvent, a glycol ether solvent and a mixture of the above.

10. The thermosetting resin composition as claimed in claim 1, wherein the resin composition further comprises a polyimide resin including cyanate ester or bismaleimide.

11. The thermosetting resin composition as claimed in claim 1, wherein the resin composition further comprises a rubber, a rubber modified compound or a rubber modified epoxy resin selected from the collection of styrene/butadiene copolymer, butadiene/styrene and methyl methacrylate or other vinyl polymer, methyl methacrylate/butadiene/styrene rubber core-shell particles, modified epoxy resin or phenolic resin, polydimethylsiloxane core-shell particles or their modified epoxy resin or phenolic resin and CTBN.

12. The thermosetting resin composition as claimed in claim 1, wherein the resin composition further comprises a filling selected from the collection of crystalline, melted type, hollow and spherical silicon dioxide, aluminum oxide, mica, talcum powder, boron oxide, aluminum nitride, silicon carbide, diamond, burned clay, aluminum oxide, aluminum nitride fiber, glass fiber and a mixture of the above.

13. The thermosetting resin composition as claimed in claim 1, wherein the resin composition further comprises an additive selected from the collection of a defoaming agent, a coupling agent, a leveling agent, a dye, a pigment, and a mixture of the above.

14. The thermosetting resin composition as claimed in claim 1, wherein the printed circuit board (PCB) adopts applications of a copper clad laminate and a prepreg.
